(19) United States
(12) Patent Application Publication
(10) Pub. No.: US 2007/0037615 A1
(43) Pub. Date: Feb. 15, 2007

(54) Wireless communication headset with RF module for accessory speaker and system utilizing same

(75) Inventor: Abraham Glezerman, Tel-Aviv (IL)

Correspondence Address: DARBY & DARBY P.C., P. O. BOX 5257, NEW YORK, NY, 10150-5257, US

(73) Assignee: Cardo Systems, Inc.

(21) Appl. No.: 11/202,762

(22) Filed: Aug. 12, 2005

(51) Int. Cl. H04M 1/00

(52) U.S. Cl. 455/575.2

(57) ABSTRACT

A wireless communication headset for use with an electronic device comprises a first headset housing a first speaker, a first module providing communication over a first protocol with the electronic device, and a circuit connecting the first speaker so as to receive signals from the first module. A second module is provided which is electrically connected through the circuit to the first module, the second module including a transmitter providing one-way communication over a second protocol which is non-compliant with the first protocol. A second headset which is independent of the first headset includes a second speaker and a receiver compliant with the second protocol, the receiver providing signals to the second speaker.

### FIELD OF THE INVENTION

The present invention relates generally to wireless communication systems that transmit and receive electronic signals wirelessly, and more particularly to headsets for reproducing mono and stereo sound.

### BACKGROUND OF THE INVENTION

Modem communication networks that may involve several movable components or devices are often plagued by an overabundance of cables to provide the connections. One solution to this problem is a wireless network communication protocol called Bluetooth, named after Danish King Harald Bluetooth, who is known for unifying Denmark and Norway in the 10^{th} century. The system was developed through the cooperative efforts of several computer and telecommunications manufacturers including Ericsson, IBM, Intel, Nokia and Toshiba. The Bluetooth technology is a telecommunication protocol which dispenses with cables and has at its core devices of low cost and low power consumption. Portable devices can be made Bluetooth compliant through the installation of an appropriate chip.

The benefits of using Bluetooth communication among network devices are numerous. Data can be freely transmitted by direct radio communication between devices at high speeds with low power consumption. Since no remote base station is required to accomplish communication between devices, system operation does not incur any standby tire, as when base station communication loads become excessive. Further, the task of connecting various computer and communication devices is greatly simplified when one can dispense with cables and allow Bluetooth technology to create an ad hoc network.

The principles of Bluetooth device operation and communication protocols are described in Specification of the Bluetooth System, Volumes 1 and 2. Bluetooth is characterized by several features. Devices using this protocol communicate over the 2.4 GHz Industrial, Scientific and Medical band at a peak air link speed of one Mbps with power consumption low enough for use in personal, portable electronics such as PDAs and cellular phones. The wireless personal area networks thus formed utilize low cost, low power wireless devices that have a typical range of ten meters. Bluetooth compliant devices are designed to seek other Bluetooth devices within their ten meter radio communications range and determine what services they offer. Two such devices can establish a connection after an inquiring device sends out an inquiry message searching for other devices in its vicinity. The inquiry message will be recognized by another Bluetooth device that is listening by conducting an inquiry scan, and said device will respond.

The establishment of a connection causes the inquiring device to become the master and the responding device to become the slave in the resulting piconet. The inquiring device establishes a connection by entering the page state and sending a paging message, using information received in the inquiry response packet, to the responding device. The inquiring/paging device temporarily synchronizes with the responding device using the responding device's access code and an estimate of the responding device's clock. The paging message sent by the inquiring/paging device is a frequency hop synchronization (FHS) packet which contains an assigned active member address (AM_ADDR) and all other information required by the responding device to reply directly to the inquiring/paging device, including the inquiring/paging device's correct device access code and clock value. In order to receive the paging packet and connect with the inquiring/paging device, the responding device must be in the page scan state to allow the inquiring/paging device to connect with it. A page acknowledgment packet will then be sent by the responding device, enabling the two devices to form a connection and transition into the connection state. A new ad hoc network piconet is thus formed, with the inquiring/paging device that initiated the connection assuming the role of master device and the responding device assuming the role of slave device, using the clock timing and access code of the master device.

Each piconet formed in this manner has a single master device and as many as seven active slave devices. Communication in the network is initiated by the master device and occurs only between the master device and each slave device. Two slave devices cannot communicate directly with each other. They must communicate through the master device.

Single-ear headsets that communicate via the Bluetooth protocol with cellular phones are represented in the prior art. U.S. Pat. No. 6,892,082 issued to Boesen discloses an embodiment wherein a handheld personal electronic device is connected wirelessly to a single earpiece headset which includes a speaker and microphone. U.S. Design Pat. No. 494,568 issued to Pan illustrates one possible realization of a single Bluetooth headset.

Wireless headset systems, particularly those intended for use with stereophonic sound systems, are well known. Early wireless headsets were most commonly used by music enthusiasts who preferred the freedom and ease offered by not being tethered to a receiver by a cable. The communication protocol for these early headsets was standard RF communication. U.S. Pat. No. 6,658,267 issued to Baranowski, et al., discloses a wireless headset which incorporates a microphone for transducing speech of a user as an outgoing audio signal, a broadband AM/FM radio signal receiver, an FM demodulator, a wireless telephone transceiver, as well as a stereo decoder for decoding commercial stereo radio signals transmitted by a phone unit. U.S. Pat. No. 6,466,677 issued to Bush discloses a wireless digital audio headphone which incorporates a memory slot and processor for retrieving digitally stored audio information form a memory card. Infrared headsets are known in the art as well, such as the invention disclosed in U.S. Pat. No. 6,421,426 issued to Lucey, which provides a line of sight transmission, infrared wireless headset for use with a telephone system.

There is a need in the art for stereo-capable or dual-mono reproduction of sound in wireless headsets and the present invention addresses this and other needs.

### SUMMARY OF THE INVENTION

According to one aspect of the present invention, a wireless communication headset for use with an electronic device comprises a first headset housing a first speaker, a first module providing communication over a first protocol with the electronic device, and a circuit connecting the first speaker so as to receive signals from the first module. A second module, electrically connected through the circuit to the first module, includes a transmitter providing at least one-way communication over a second protocol which is non-compliant with the first protocol. A second headset, independent of the first headset, includes a second speaker and a receiver compliant with the second protocol, the receiver providing signals to the second speaker.

### BRIEF DESCRIPTION OF THE DRAWINGS

FIG. 1 is a perspective view of a wireless communication headset system including independent first and second headset units in accordance with a preferred embodiment.

FIG. 2 is a side view of the second headset unit of FIG. 1.

### DETAILED DESCRIPTION OF A PREFERRED EMBODIMENT

By way of overview and introduction, the present invention provides a user with a multi-piece headset whose connections are entirely wireless, from signal source to final receiving component. As compared to known wireless headsets, the multi-piece headset of the present invention includes an accessory headset that provides a second speaker for completing delivery of stereo or dual-mono sound to the user. As an improvement over the art, the accessory headset communicates wirelessly with the primary headset using a different protocol than the primary headset utilizes for communication with an electronic device such as a phone, radio or music player.

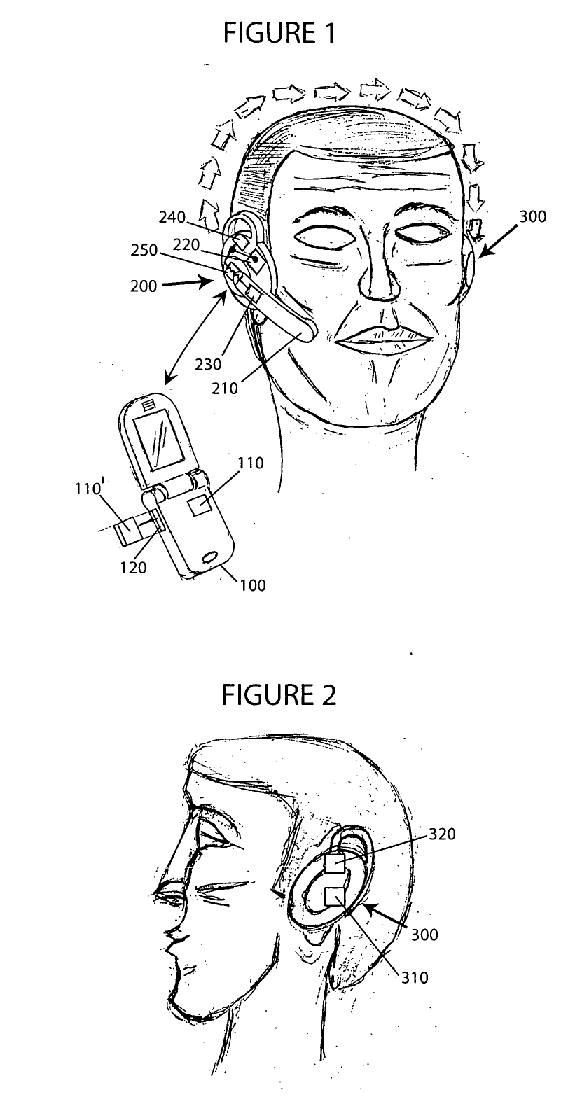

FIG. 1 is a system diagram of one embodiment of the invention, showing schematically how the various components communicate and are oriented with respect to one another and with respect to the user's head.

An electronic device 100 such as a cellular phone or MP3 music player sources signals which are transmitted (and optionally received) over a first protocol. Preferably, the first protocol is the Bluetooth Standard, a mode of establishing wireless personal area networks which operates in the 2.4 GHz Industrial, Scientific, and Medical (ISM) band. A Bluetooth personal area network or piconet is comprised of a single master device, which controls all network functions including when devices can communicate, and up to seven slave devices.

The electronic device 100 can include circuitry 110 to enable communication on over first protocol (e.g., chips that support Bluetooth communication), or such circuitry can be disposed external of the device (circuitry 110′) and be connected to the device through an interface 120.

All communication within the personal area network using the first protocol is through the circuitry 110, 110′ of the “master” device, such as the phone or MP3 player. Slave devices communicate over the first protocol with the master, but cannot communicate with one another directly. In the illustrated embodiment, there is one slave device, namely a first headset 200, which communicates via the first protocol.

The first headset 200 includes several components that are commercially available, including a speaker 220 and a communication module 230 which is compliant with the first protocol. The speaker and the communication module are connected by a circuit 250 which can be of arbitrary complexity and include digital-to-analog converters, frequency filters, amplifiers, and other conventional circuitry in order to permit the speaker 220 to receive signals that are suitable for reproduction. Alternatively, the circuit can comprise a conductive wire connecting the communication module and the speaker together. Optionally, the headset 200 includes a microphone 210 to enable use of the headset with two-way communication devices such as phones and walkie-talkies.

The headset 200 includes a second module 240 which is electrically connected through the circuit 250 to the first module 230. The circuit 250 can provide signal conversion, filtration and amplification, as described above, and other decoding (e.g., to decode a stereo signal) upon signals that are communicated to the headset 200 from the electronic device. The second module 240 is constructed so as to enable communication of signals that have been coupled through the circuit 250 to a second headset 300. In other words, the second module 240 includes a transmitter circuit that radiates in a wireless manner signals received through the circuit 250 exteriorly of the first headset. This is a departure from conventional devices that have relied upon the Bluetooth Standard alone because the headset in that arrangement is a slave able to communicate only with its master (the electronic device 100).

In accordance with a salient aspect of the invention, the second module 240 transmits signals over a second communication protocol which differs from (that is, which is non-compliant with) the first protocol. In the preferred embodiment, the second protocol is a low-power radio-frequency (“RF”) transmission, such that signals are communicated from the electronic device using the Bluetooth Standard to the first headset 200 and communicated from the first headset 200 to the second headset 300 using low-power RF transmission.

A second headset 300 includes a receiver 310 which receives signals communicated from the first headset 200. Preferably, the receiver is an RF receiver tuned to a center frequency at which the second module 240 transmits. The receiver outputs the received signals so as to drive a speaker 320 and permit sound reproduction from the second headset 300.

In use, a user having an electronic device 100 equipped with circuitry 110 suitable for communicating over the first protocol need only place the first headset 200 about his or her hear. The headset 200 optionally includes controls such as controls that permit the user to answer a call, mute the microphone (if provided), mute the speaker. If the electronic device 100 lacks circuitry 110, then an outboard circuit 110′ can be connected through the interface 120.

The user receives signals from the electronic device 100 via circuit 110, 110′ over the first protocol. These received signals are coupled to the speaker and, optionally, signals emanating with the user (or his or her environment) that have been coupled by the microphone 210 can be communicated back to the electronic device 100.

In this manner, the user is in wireless communication with the electronic device, and has sound available at one ear. At the same time, in accordance with the invention, signals are conveyed using a second protocol from the first headset to the second headset for play through the speaker 310. These signals can be the same as provided to speaker 220 (for dual-monaural reproduction) or can be another signal (e.g., in support of stereo playback).

While the invention has been described in connection with a certain embodiment thereof, the invention is not limited to the described embodiments but rather is more broadly defined by the recitations in the claims below and equivalents thereof.

What is claimed is:

1. A wireless communication headset for use with an electronic device, comprising:
a first headset housing a first speaker, a first module providing communication over a first protocol with the electronic device, and a circuit connecting the first speaker so as to receive signals from the first module;
a second module electrically connected through the circuit to the first module, the second module including a transmitter providing one-way communication over a second protocol which is non-compliant with the first protocol; and
a second headset independent of the first headset and including a second speaker and a receiver compliant with the second protocol, the receiver providing signals to the second speaker.

2. The system of claim 1, wherein the first headset further houses a microphone for transducing sounds into audio signals.

3. The system of claim 2, wherein the first module provides two-way communication between the first headset and the electronic device.

4. The system of claim 2, wherein the second headset lacks a microphone.

5. The system of claim 1, wherein the first protocol is Bluetooth compliant.

6. The system of claim 1, wherein the transmitter has an output suitable for local transmission to the second headset.
